(19) United States
(12) Patent Application Publication
(10) Pub. No.: US 2015/0170222 A1
(43) Pub. Date: Jun. 18, 2015

(54) SYSTEM AND METHOD FOR CONTROLLED PURCHASING OF ONLINE ADVERTISEMENTS IN A REAL-TIME BIDDING ENVIRONMENT

(71) Applicant: MaxPoint Interactive, Inc., Morrisville, NC (US)

(72) Inventor: Michael Els, Durham, NC (US)

(73) Assignee: MaxPoint Interactive, Inc., Morrisville, NC (US)

(21) Appl. No.: 14/133,553

(22) Filed: Dec. 18, 2013

(51) Int. Cl. G06Q 30/02

(52) U.S. Cl. CPC G06Q 30/0275

(57) ABSTRACT

A system and method for controlled purchasing of online advertisements in a real time bidding environment is herein disclosed. According to one embodiment, the computer-implemented method includes receiving a real-time bidding request for an online advertisement campaign and determining a score of the real-time bidding request. The score elicits desirability for the online advertisement campaign. The computer-implemented method further includes determining a pacing threshold for the online advertisement campaign and bidding on the real-time bidding request based on the score of the real-time bidding request and the pacing threshold. A bidding pace of the online advertisement campaign is monitored based on a number of impressions won for a given time period, and the pacing threshold is dynamically adjusted based on the bidding pace.

### FIELD

The present disclosure relates in general to the field of computer software and systems, and in particular, to a system and method for controlled purchasing of online advertisements in a real-time bidding environment.

### BACKGROUND

Online advertisement placements generally refer to the slots or space on the pages of a website that are available for displaying advertisements along with their content. Advertisers typically bid on these advertisement placements that are made available through real-time bidding (RTB) exchanges such as AdX, Admeld, Pubmatic, etc.

From a mechanical perspective, online advertisement placement requires a bidding server connected to RTB exchanges. The bidding server then receives bid requests via the RTB exchanges. A bid request occurs when a user/Internet surfer visits a website or publisher that is selling their advertisement space on an RTB exchange. Upon receiving a bid request, the bidding server has a very short period of time to respond to this request (generally under 50 ms). Since this bid response needs to occur in a very short period of time, it is difficult to run large scale models to predict what advertisements to buy and what price to pay for them.

At bid time, the bidding server has to act on some set of rules, models or system instructions that indicate which bid requests it should bid or pass on. This is a non-trivial problem since there are numerous (e.g., billions) requests that could be bought at any given time, those requests are very different and occur randomly throughout the day, and each request needs to be evaluated in milliseconds.

### SUMMARY

A method and system for controlling an amount of online advertisements being bought in a real-time bidding (RTB) environment is disclosed. According to one embodiment, a computer-implemented method includes receiving a real-time bidding request for an online advertisement campaign and determining a score of the real-time bidding request. The score elicits desirability for the online advertisement campaign. The computer-implemented method further includes determining a pacing threshold for the online advertisement campaign and bidding on the real-time bidding request based on the score of the real-time bidding request and the pacing threshold. A bidding pace of the online advertisement campaign is monitored based on a number of impressions won for a given time period, and the pacing threshold is dynamically adjusted based on the bidding pace.

The above and other preferred features, including various novel details of implementation and combination of elements, will now be more particularly described with reference to the accompanying drawings and pointed out in the claims. It will be understood that the particular methods and circuits described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWINGS

The accompanying figures, which are included as part of the present specification, illustrate the various embodiments of the presently disclosed system and method and together with the general description given above and the detailed description of the embodiments given below serve to explain and teach the principles of the present system and method.

FIG. 1 illustrates a flowchart for dynamically adjusting a bid pacing, according to one embodiment;

FIG. 2 illustrates an exemplary time series of impressions, according to one embodiment;

FIG. 3 illustrates an application of an exemplary control process to a time series data, according to one embodiment;

FIG. 4 illustrates an exemplary plot for a dynamic pacing process, according to one embodiment; and

FIG. 5 illustrates an exemplary computer architecture that may be used for the present system, according to one embodiment.

FIG. 6 illustrates an exemplary system level architecture for use with the present system, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

A system and method for controlled purchasing of online advertisements in a real time bidding environment is herein disclosed. According to one embodiment, the computer-implemented method includes receiving a real-time bidding request for an online advertisement campaign and determining a score of the real-time bidding request. The score elicits desirability for the online advertisement campaign. The computer-implemented method further includes determining a pacing threshold for the online advertisement campaign and bidding on the real-time bidding request based on the score of the real-time bidding request and the pacing threshold. A bidding pace of the online advertisement campaign is monitored based on a number of impressions won for a given time period, and the pacing threshold is dynamically adjusted based on the bidding pace.

Each of the features and teachings disclosed herein can be utilized separately or in conjunction with other features and teachings to provide a system and method for combining past user events with real-time user events to rapidly respond to advertising opportunities. Representative examples utilizing many of these additional features and teachings, both separately and in combination are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of processes and symbolic representations of operations on data bits within a computer memory. These process descriptions and representations are the means used by those skilled in the data processing arts to most effectively convey the substance of their work to others skilled in the art. A process is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. The steps are not intended to be performed in a specific sequential manner unless specifically designated as such.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” or the like, refer to the action and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The methods or processes presented herein are not inherently related to any particular computer or other apparatus. Various general purpose systems, computer servers, or personal computers may be used with programs in accordance with the teachings herein, or it may prove convenient to construct a more specialized apparatus to perform the method steps. The structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure. It is also expressly noted that the dimensions and the shapes of the components shown in the figures are designed to help to understand how the present teachings are practiced, but not intended to limit the dimensions and the shapes shown in the examples.

A method and system for controlling the amount of online advertisements being bought in a real-time bidding environment is disclosed. The objective of the present dynamic pacing system is to win a desired number of bids to meet the impression quota of a particular advertisement campaign. The present dynamic pacing system affects the number of bids won by adjusting a bidding pace. Since winning a bid request is not a guaranteed process, this adds a stochastic element to the present system and method. According to one embodiment, a computer-implemented method includes receiving a real-time bidding request for an online advertisement campaign and determining whether or not to bid on the online advertisement. According to one embodiment, the bidding process for online advertisements includes scoring bid requests and deciding whether or not to bid after evaluating the score.

According to one embodiment, each bid request is given a relative level of desirability for purchase. Examples of such scores include a numerical score, a rank, a preference order, or a category to purchase or a general grouping concept. For example, an incoming bid request is scored numerically on a scale between 0 and 20, where 0 is do not bid and 20 indicates the most desirable bid request. It is contemplated that any type of scoring schemes may be used to indicate a relative level of desirability without deviating from the present subject matter.

According to one embodiment, a dynamic pacing system is employed to determine whether or not to bid based on desirability scores. The present dynamic pacing system moves around a pacing threshold score optimally so that enough bid requests are won to serve the desired number of online advertisements (impressions) in a time period.

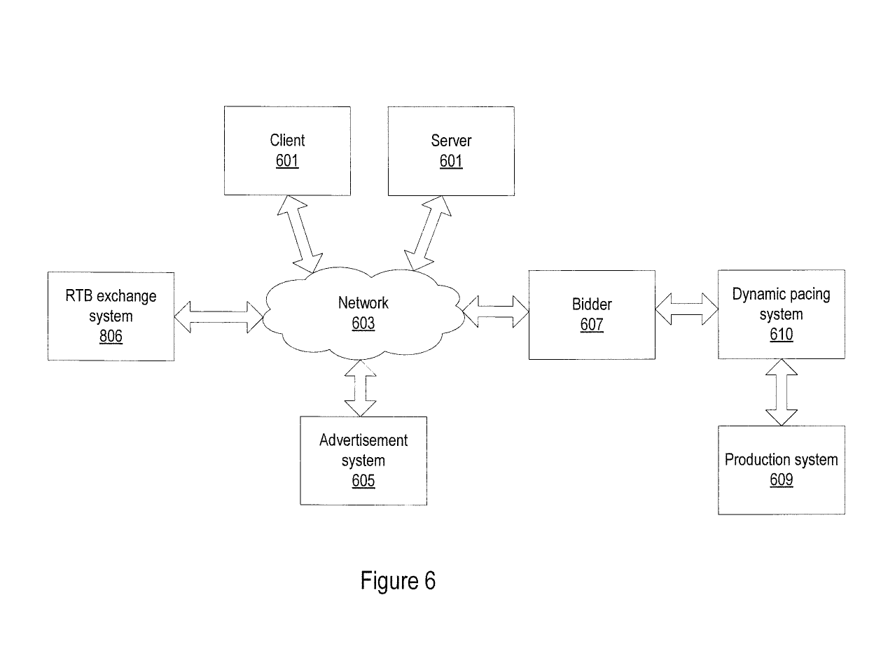

The present dynamic pacing system needs a target number for how many impressions to serve in a given time interval. The first input into the dynamic pacing system is the number of desired target impressions to win in any given time period. FIG. 6 illustrates an exemplary system level architecture for use with the present system, according to one embodiment. A client 601 having a browser views a webpage hosted by a server 608 via a network 603. An RTB exchange system 606 provides a real-time bidding request for serving an advertisement impression to a bidder 607. Although FIG. 6 only illustrates one bidder 607, it is understood that the present system can support any number of bidders. The RTB exchange system 606 further receives a bid response from the bidder 607. The bidder 607 and/or an advertisement system 605 can select an appropriate advertisement and place the selected advertisement to the client 601 on a webpage of the server 608. A production system 609 creates and provides a list of rules to the bidder 607. The bidder 607 uses the list of rules to score a real-time bidding request. The production system 609 further references a campaign setup, goals and requirements and creates a delivery plan of impression targets for the planned lifetime of the campaign. The delivery plan allocates a desired number of impressions to win within a specified time period (e.g., Tuesday afternoons, a time period of rain at a desired geographical area). The production system 609 provides a dynamic pacing system 610 with the delivery plan, i.e., a desired number of impressions to serve within a specified time period. The production system 609 partitions the delivery plan into smaller time segments so that the dynamic pacing system 610 can more accurately manage impression purchasing. An exemplary delivery plan includes, but is not limited to, setting different impression quotas for a given period of time (e.g., a month, a week, a day, an hour, a minute, or any combination of those time periods). The dynamic pacing system 610 determines and provides a pacing threshold score for a bidding request so that the bidder 607 provides a bid if the score of the bidding request satisfies the pacing threshold score. The dynamic pacing system 610 dynamically adjusts the pacing threshold score based on the number of the bidding requests won and a target number of bidding requests to win during a specified time period.

As a campaign runs, the desired campaign goal may not be met for a given time period. In this case, the present dynamic pacing system updates the campaign goal over time. In one embodiment, the dynamic pacing system periodically updates campaign goals based on the number of impressions won and any campaign rule changes that may have occurred. The present dynamic pacing system recomputes the delivery plan based on the desired number of impressions to win during a specified time period and the remaining impressions to achieve the campaign target.

Based on the campaign goal or the desired target number of impressions to win for a given time period and the score of bid request received, the present dynamic pacing system selects a pacing threshold value within the scoring range (e.g., 0-20). In one embodiment, the pacing threshold value is initially set to the maximum score which represents the most desirable bid requests. Starting at the maximum score represents bidding on the fewest and the best bid requests. The pacing threshold value set by the present dynamic pacing system is the minimum value that a bid request must have to be allowed to bid on it. The present dynamic pacing system then periodically checks the number of bids that were won in the previous time period and compares it to the target number of impressions to win in the next time period. The present dynamic pacing system dynamically adjusts the pacing threshold value. For example, the present dynamic pacing system attempts to raise the threshold value to win fewer impressions. If the maximum threshold value is set, then the present dynamic pacing system cannot further raise the threshold and the campaign would serve out too quickly. Similarly, if the minimum threshold value is set, the present dynamic pacing system cannot further lower the threshold to win more bid requests, and the campaign will be underserved. From a system point of view, these corner cases trigger feedback for user input or system intervention to remedy the situation. In general, most campaigns do not fall into these corner cases and the pacing threshold can be adjusted as needed to meet the impression goal for a given time interval.

The threshold value need not simply just be the minimum cutoff value applied at a bid time to select which bid requests to bid on. Instead, the threshold value can be seen as a measure for how hard the present dynamic pacing system is trying to win impressions. For example, a threshold value close to the maximum score (e.g., 20) means that the system does not have a difficult time winning sufficient impressions for a given campaign. This could further trigger a variety of system changes that also affect bidding pacing. For example, threshold values close to the maximum score (e.g., 20) trigger changes to be more selective of users to bid on. In another example, the present dynamic pacing system lowers the bidding prices. Lower bid prices generally lead to fewer wins. Similarly, low threshold values indicate that the system is having trouble winning the desired number of impressions with the given rule set. In this case, the dynamic pacing system starts to be less picky with the users to bid on or bid on higher prices for the requests than it deems desirable.

In order to adjust the threshold value and change bidding parameters based on bidding pacing, the dynamic pacing system accounts for the number of impressions that are being won given the current threshold. An exemplary equation for determining a sum of a conditional expectation (sumE) of a number of impressions that are won given a pacing threshold score at a point in time is:

sumE[I|T],

where I is a number of impressions that are being won and T is a pacing threshold score at a point in time.

Typically, determining the number of impressions won is measured on a noisy time series, therefore it is difficult to adjust the threshold value with confidence. There is an uncertainty as to how many impressions that the system is purchasing at a given threshold. The present system may buy more or less impressions because of a change to the threshold value or a change in activity in a RTB exchange system (e.g., more advertisements available for purchase). Otherwise, there could be a large random fluctuation in the time series. In one embodiment, in order to more accurately estimate the number of bid requests that are being won, the present dynamic pacing system applies a smoothing process to smooth a data set and separate the signal from the noise. For example, the present dynamic pacing system applies a Kalman filter over an observed time series. After calibrating this model it gives a much more accurate representation of how many requests are being won at any given time interval.

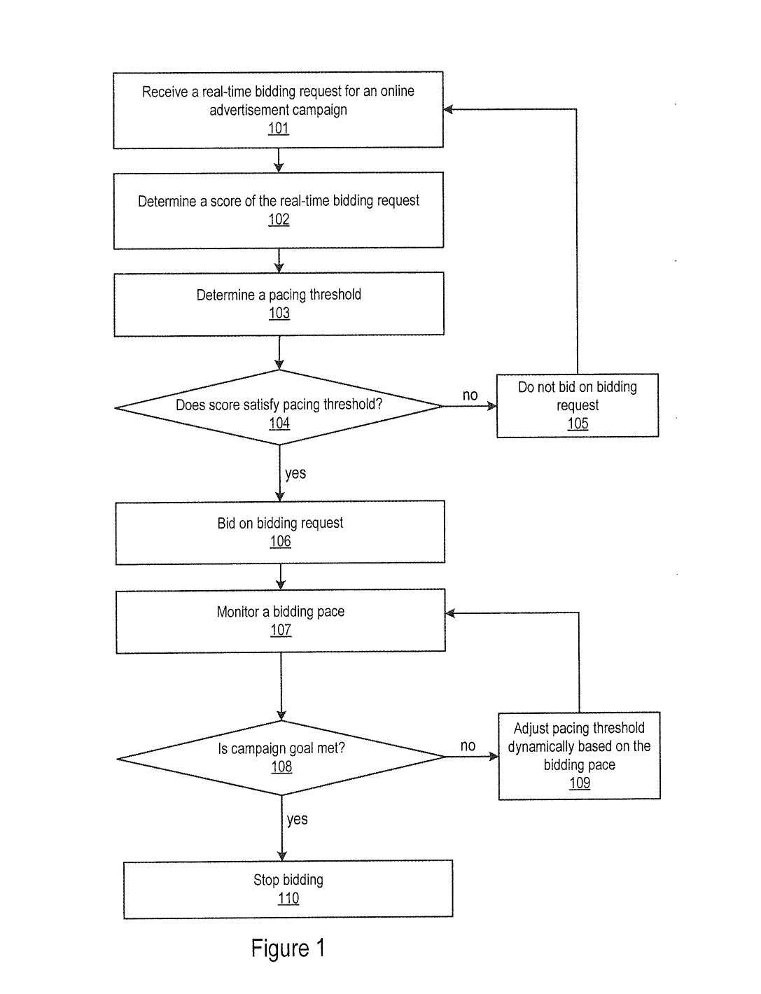

FIG. 1 illustrates a flowchart for dynamically adjusting a bid pacing, according to one embodiment. The present dynamic pacing system receives a real-time bidding request for an online advertisement campaign at 101. The present dynamic pacing system determines a score of the real-time bidding request at 102. The score of the real-time bidding request elicits desirability for the online advertisement campaign. The present dynamic pacing system also determines a pacing threshold for the online advertisement campaign at 103. The present dynamic system determines whether the score of the real-time bidding request satisfies the pacing threshold at 104. If the score does not satisfy the pacing threshold, the present dynamic pacing system does not bid on the bidding request at 105 and the process returns to 101. If the score satisfies the pacing threshold, the present dynamic pacing system bids on the real-time bidding request based on the score of the real-time bidding request and the pacing threshold at 106. As the online advertisement campaign continues, the present dynamic pacing system monitors a bidding pace of the online advertisement campaign based on a number of impressions won for a given time period at 107. The present dynamic pacing system determines whether the goal of the online advertisement campaign is met at 108. If the goal is not met for a particular time period, the present dynamic pacing system dynamically adjusts the pacing threshold based on the bidding pace at 109. If the goal of the online advertisement campaign is met, the present dynamic pacing system stops bidding on the online advertisement campaign at 110.

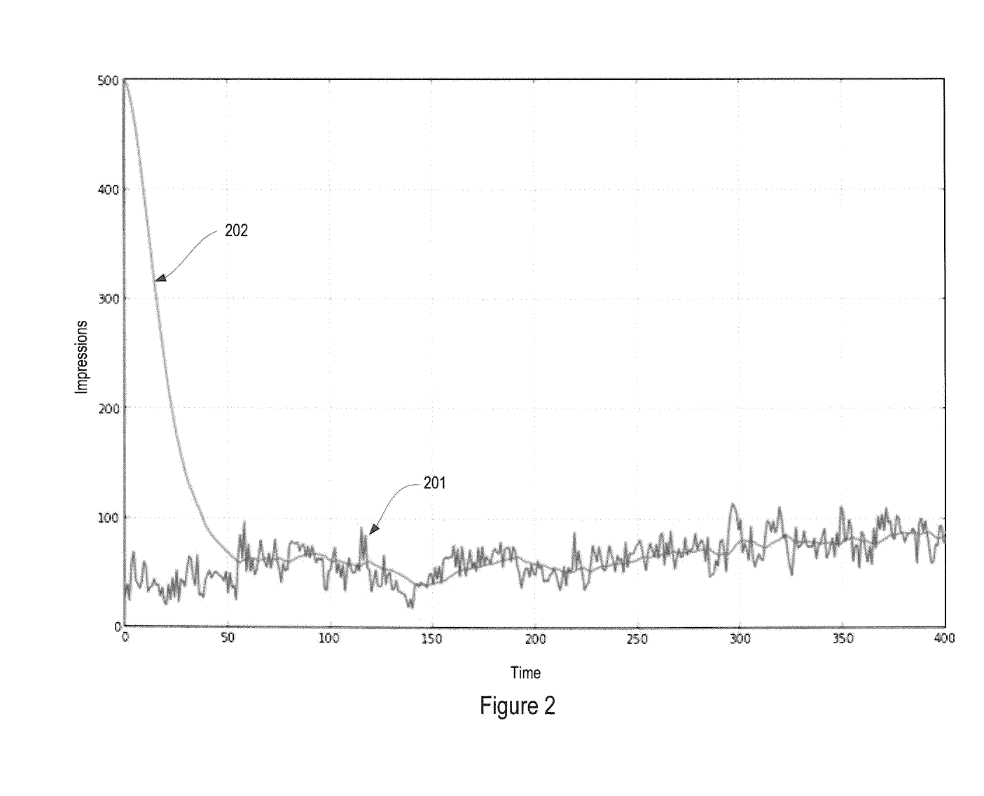

FIG. 2 illustrates an exemplary time series of impressions, according to one embodiment. A Kalman filter is applied to the time series of impressions that are won. The number of impressions won can vary, therefore the present system observes the data and adjusts its prediction at each time period. The vertical axis represents the number of impressions won and the horizontal axis represents the time interval. The line 201 indicates the number of impressions that are actually won at each time period and the line 202 indicates a Kalman filter's prediction of the number of impressions that are expected to be won in a given time period.

Based on the Kalman-filtered number of impressions that are won in a previous time period, the present dynamic pacing system accurately measures how far it is from achieving the campaign goal. Using the difference between the Kalman-filtered number of impressions won and a desired number of impressions to be won for a specified time period, the present dynamic pacing system estimates how far it is off the pacing and in which direction the pacing needs to be adjusted. In one embodiment, a control process is employed to calculate in which direction the threshold value is to be adjusted and the size of the adjustment. An example of such a control process is a proportional-integral-differential (PID) control process. The PID control process takes in an error value (i.e., the difference between a Kalman estimate and a goal). The PID control process is an online process, i.e., the PID control process computes input data serially, thus it does not need to run over historical data, and it relies on the information in its current state which is updated with the latest error. In one embodiment, the output of the PID control process is a change variable such as a threshold value and the amount of change to the threshold value. The present dynamic pacing system accounts for the last change made to the threshold and adjusts the threshold value based on various factors, including but not limited to, the proportion of the last error, the sum (or integral) of previous errors, and the differential change in the error from the previous time period to the current time period.

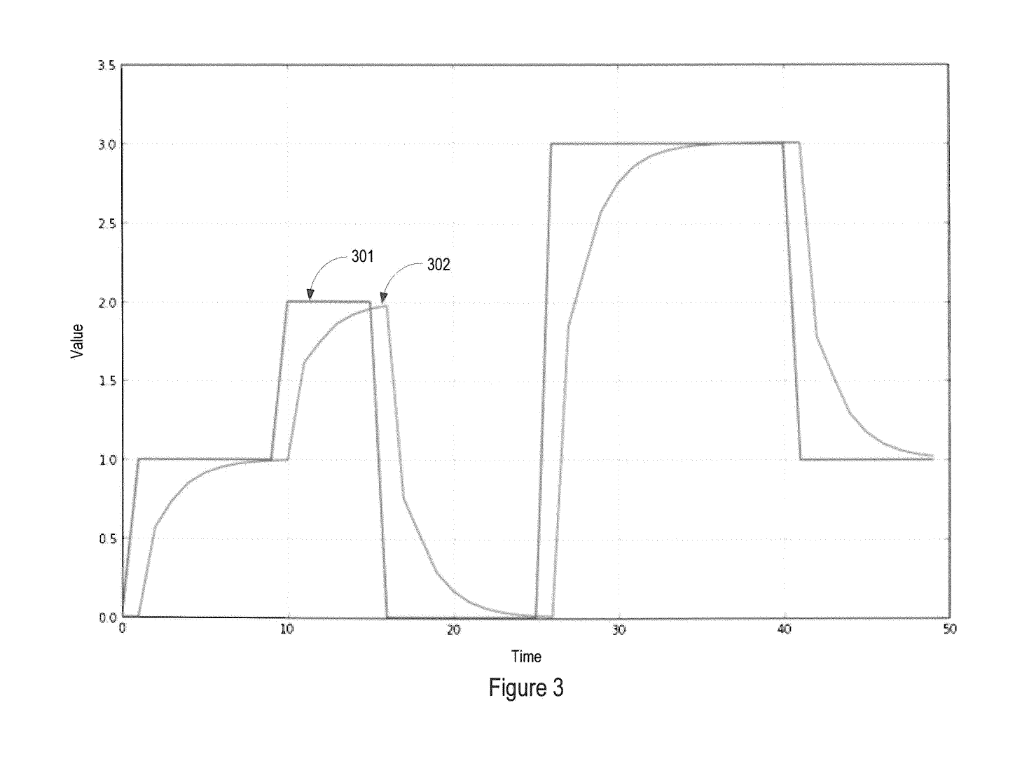

FIG. 3 illustrates an application of an exemplary control process to a time series data, according to one embodiment. The vertical axis represents the process value (e.g., a number of impressions) that the present dynamic pacing system tries to manipulate. The horizontal axis represents the time period. The line 301 indicates a desired process value that the present system would like to be at for each time period. The line 303 indicates a process value the system is currently at for each time period. As the line 301 moves over time, the PID controller moves the line 302 until it reaches the desired target set by the line 301.

PID controllers are generally sensitive to the system that they are trying to control. Much of their commercial applications rest on experts tuning the PID parameters to fit the system they are trying to control. According to one embodiment, the present dynamic pacing system operates automatically for tuning and adjusting the PID parameters based on the current status of the system. Multiple optimization techniques can be employed for tuning the PID parameters. One does not need to tune the PID parameters directly; instead, a heuristic tuning method such as Ziegler-Nichols method or any other variant may be employed to tune the PID parameters. In one embodiment, the present dynamic pacing system employs a particle swarm optimization and evaluates the PID parameters after every step taken. The present dynamic system looks back at the previous time period and simulates the step size the present dynamic system would have taken if the PID parameters were some other value. In this case, the present dynamic pacing system decides which alternative PID parameter values to evaluate. For example, each of the PID parameter values is adjusted at a time in both possible directions (greater and smaller) and a simulation is performed for each PID value or every combination of PID values. After the simulation is completed, the present dynamic pacing system compares the step size that all other theoretical PID models would have taken in the last period to the step size that is actually taken by the current PID model. By evaluating the step size of all the PID models, the present dynamic pacing system selects the PID model that takes the best step size based on the set of PID parameter values that provided a closest impression goal. This moves the current PID model slightly in a parameter space. At each iteration, the PID model is constantly adjusted based on how well it is suited to the current optimization task (e.g., how to adjust the threshold value) it has been given.

According to one embodiment, the present dynamic pacing employs an optimization that is based on customized business rules. Examples of business rules include, but are not limited to, the biggest step size that the present dynamic pacing system can select in set time intervals, the maximum and minimum threshold values, and system stability checks.

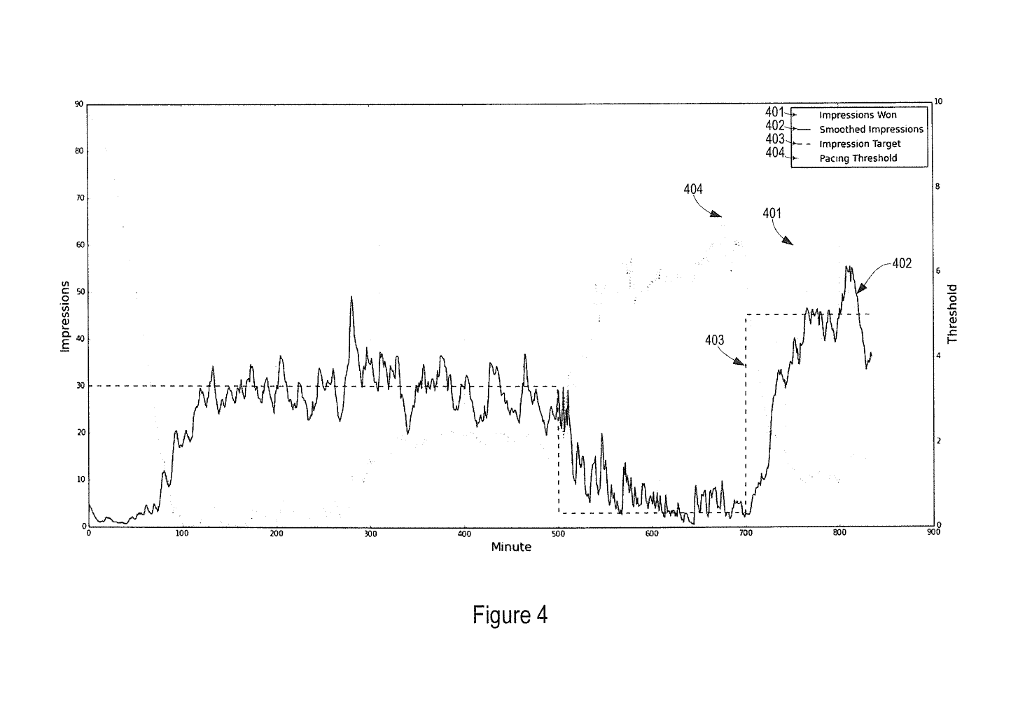

FIG. 4 illustrates an exemplary plot for a dynamic pacing process, according to one embodiment. The impression target 403 is arbitrarily set to determine how well the PID control process works to hit the pacing goal. The line 401 indicates the number of impressions that are actually won at each time period. The line 402 indicates a filtered number of impressions that are expected to be won at each time period. In one embodiment, the line 402 may be determined by employing a Kalman filter to the line 401. The pacing threshold line 404 is adjusted by the auto-tuning PID controller in order to move the line 402 towards the impression target 403 as best as possible.

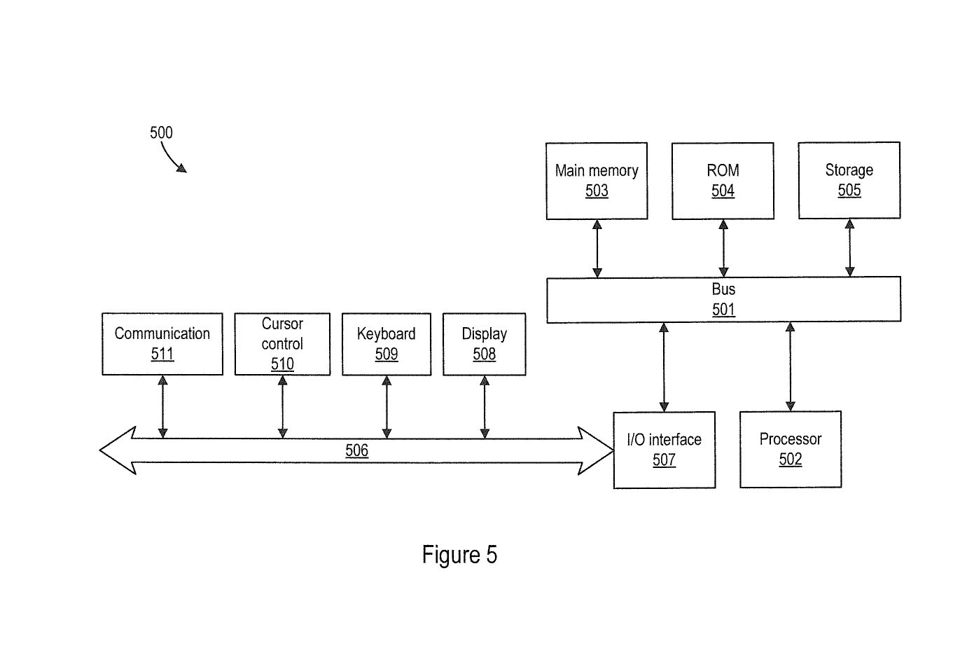

FIG. 5 illustrates an exemplary computer architecture that may be used for the present system, according to one embodiment. The exemplary computer architecture may be used for implementing one or more components described in the present disclosure including, but not limited to, the present system. One embodiment of architecture 500 includes a system bus 501 for communicating information, and a processor 502 coupled to bus 501 for processing information. Architecture 500 further includes a random access memory (RAM) or other dynamic storage device 503 (referred to herein as main memory), coupled to bus 501 for storing information and instructions to be executed by processor 502. Main memory 503 also may be used for storing temporary variables or other intermediate information during execution of instructions by processor 502. Architecture 500 may also include a read only memory (ROM) and/or other static storage device 504 coupled to bus 501 for storing static information and instructions used by processor 502.

A data storage device 505 such as a magnetic disk or optical disc and its corresponding drive may also be coupled to architecture 500 for storing information and instructions. Architecture 500 can also be coupled to a second I/O bus 506 via an I/O interface 507. A plurality of I/O devices may be coupled to I/O bus 506, including a display device 508, an input device (e.g., an alphanumeric input device 509 and/or a cursor control device 510).

The communication device 511 allows for access to other computers (e.g., servers or clients) via a network. The communication device 511 may include one or more modems, network interface cards, wireless network interfaces or other interface devices, such as those used for coupling to Ethernet, token ring, or other types of networks.

The above example embodiments have been described herein above to illustrate various embodiments of implementing a system and method for estimating an advertisement impression volume. Various modifications and departures from the disclosed example embodiments will occur to those having ordinary skill in the art. The subject matter that is intended to be within the scope of the present disclosure is set forth in the following claims.

We claim:

1. A computer-implemented method, comprising:
receiving a real-time bidding request for an online advertisement campaign;
determining a score of the real-time bidding request, wherein the score elicits desirability for the online advertisement campaign; and
determining a pacing threshold for the online advertisement campaign;
bidding on the real-time bidding request based on the score of the real-time bidding request and the pacing threshold;
monitoring a bidding pace of the online advertisement campaign based on a number of impressions won for a given time period; and
adjusting the pacing threshold dynamically based on the bidding pace.

2. The computer-implemented method of claim 1, wherein adjusting the pacing threshold dynamically further comprises employing a control process.

3. The computer-implemented method of claim 2, wherein the control process employs a proportional-integral-derivative (PID) control using a difference between an impression target of a given time period and the number of impressions won.

4. The computer-implemented method of claim 2, further comprising tuning automatically a parameter of the control process to optimize the pacing threshold.

5. The computer-implemented method of claim 4, wherein tuning automatically the parameter of the control process is based on a particle swarm optimization process.

6. The computer-implemented method of claim 1, further comprising filtering the number of impressions won to separate a signal from a noise.

7. The computer-implemented method of claim 1 further comprising:
partitioning a delivery plan of the online advertisement campaign into a plurality of time segments; and
setting an impression quota for each time segment of the plurality of time segments;

8. The computer-implemented method of claim 7, wherein adjusting the pacing threshold dynamically further comprises raising or lowering the pacing threshold value by comparing the impression quota and the number of impressions won.

9. The computer-implemented method of claim 1, wherein the score of the real-time bidding request includes a numerical score, a rank, a preference order, a category to purchase or a general grouping concept.

10. The computer-implemented method of claim 1, wherein the score of the real-time bidding request is given within a range between a minimum score and a maximum score.

11. The computer-implemented method of claim 10, wherein the pacing threshold value is set to be a value within the range.

12. The computer-implemented method of claim 1 further comprising adjusting a bidding price of the online advertisement campaign based on the score of the real-time bidding request and the bidding pace.

13. A non-transitory computer readable medium containing computer-readable instructions stored therein for causing a computer processor to perform operations comprising:
receiving a real-time bidding request for an online advertisement campaign;
determining a score of the real-time bidding request, wherein the score elicits desirability for the online advertisement campaign; and
determining a pacing threshold for the online advertisement campaign;
bidding on the real-time bidding request based on the score of the real-time bidding request and the pacing threshold;
monitoring a bidding pace of the online advertisement campaign based on a number of impressions won for a given time period; and
adjusting the pacing threshold dynamically based on the bidding pace.

14. The non-transitory computer readable medium of claim 13, wherein adjusting the pacing threshold dynamically further comprises employing a control process.

15. The non-transitory computer readable medium of claim 14, wherein the control process employs a proportional-integral-derivative (PID) control using a difference between an impression target of a given time period and the number of impressions won.

16. The non-transitory computer readable medium of claim 14, wherein the computer-readable instructions stored therein for causing the computer processor to perform operations further comprising tuning automatically a parameter of the control process to optimize the pacing threshold.

17. The non-transitory computer readable medium of claim 16, wherein tuning automatically the parameter of the control process based on a particle swarm optimization process.

18. The non-transitory computer readable medium of claim 13, wherein the computer-readable instructions stored therein for causing the computer processor to perform operations further comprising filtering the number of impressions won to separate a signal from a noise.

19. The non-transitory computer readable medium of claim 13, wherein the computer-readable instructions stored therein for causing the computer processor to perform operations further comprising:
partitioning a delivery plan of the online advertisement campaign into a plurality of time segments; and
setting an impression quota for each time segment of the plurality of time segments;

20. The non-transitory computer readable medium of claim 19, wherein adjusting the pacing threshold dynamically further comprises raising or lowering the pacing threshold value by comparing the impression quota and the number of impressions won.

21. The non-transitory computer readable medium of claim 13, wherein the score of the real-time bidding request includes a numerical score, a rank, a preference order, a category to purchase or a general grouping concept.

22. The non-transitory computer readable medium of claim 13, wherein the score of the real-time bidding request is given within a range between a minimum score and a maximum score.

23. The non-transitory computer readable medium of claim 22, wherein the pacing threshold value is set to be a value within the range.

24. The non-transitory computer readable medium of claim 13, wherein the computer-readable instructions stored therein for causing the computer processor to perform operations further comprising adjusting a bidding price of the online advertisement campaign based on the score of the real-time bidding request and the bidding pace.
